(19) United States
(12) Patent Application Publication
(10) Pub. No.: US 2006/0055543 A1
(43) Pub. Date: Mar. 16, 2006

(54) System and method for detecting unusual inactivity of a resident

(76) Inventors: Meena Ganesh, Clifton Park, NY (US); Paul Edward Cuddihy, Ballston Lake, NY (US); Jenny Marie Weisenberg, Niskayuna, NY (US); Catherine Mary Graichen, Malta, NY (US); Mark Mitchell Kornfein, Latham, NY (US); Vrinda Rajiv, Schenectady, NY (US)

Correspondence Address: Patrick S. Yoder;FLETCHER YODER, P.O. Box 692289, Houston, TX, 77269-2289, US

(21) Appl. No.: 10/938,004

(22) Filed: Sep. 10, 2004

(51) Int. Cl. G08B 23/00

(52) U.S. Cl. 340/573.1; 340/523; 340/526

(57) ABSTRACT

A system and method for detecting a period of unusual inactivity of a person is provided. The system comprises a monitoring system, which is in communication with location and motion sensors. The monitoring system comprises a processor-based device programmed to develop a model of the person's periods of inactivity within a structure based on data received from the sensors. The processor-based device may also be programmed to determine if a current period of inactivity within the structure is a period of normal inactivity or a period of unusual inactivity based on the model of the person's periods of inactivity.

### BACKGROUND

The invention relates generally to home monitoring systems and more particularly to a system and method for detecting when a resident of a home has fallen or is incapacitated.

Many elderly people are at risk from a variety of hazards, such as falling, tripping, or illness. For example, health statistics and studies show that falling is a major problem among the elderly. The risk of falling increases with age, such that, studies suggest that about 32% of individuals above 65 years of age and 51% of individuals above 85 years of age fall at least once a year. In addition, many elderly people live alone. Therefore, the elderly are at additional risk that they may not be able to call for help or receive assistance in a timely manner after experiencing a fall or illness.

As a result, systems that enable a resident of a home to call for assistance from anywhere in a home have been developed. In addition, attempts have been made to develop systems that may be worn by a resident that will automatically send out a signal when the resident has fallen. One disadvantage of these devices is that they have to be worn by the person in order to work. These devices are useless if the person is not wearing them. In addition, a device that requires someone to activate it is useless if the person is unconscious. Thus, there is a risk that in an emergency situation, the resident may not receive the proper assistance in a timely manner.

Other systems rely on motion sensors to try to identify when a person has fallen. There may be extended periods where a resident is not moving for reasons other than the person having fallen or becoming incapacitated, such as watching television from a chair or sleeping in bed. Systems that rely on motion sensors require the person to be motionless for a considerable amount of time before the system is able to conclude that the resident has fallen or become incapacitated, as opposed to exhibiting normal inactive behavior.

There is a need for a technique for detecting when a resident of a home has fallen or become incapacitated, and which does not require the resident to wear or activate a monitoring device. Furthermore, there is a need for a monitoring system or method that will send an alert to a caregiver to provide assistance to the resident after the resident has fallen or become incapacitated. More specifically, there is a need for a technique that enables a monitoring system to decrease the amount of time that it takes for the system to recognize that a person has fallen as opposed to exhibiting normal inactive or resting behavior.

### SUMMARY

According to one aspect of the present technique, a system for detecting when a person occupying a structure is exhibiting a period of unusual inactivity is provided. The system comprises at least one location sensor operable to detect when a person is located at a specific location within the structure. In addition, the location sensor is operable to provide a signal when the person is located at the specific location. The system also comprises at least one motion sensor operable to detect activity within the structure. The motion sensor also is operable to provide a signal when the motion sensor detects activity within the structure. A processor-based system is provided and programmed to establish a normal period of inactivity within the structure based on signals received from the location sensors and the motion sensors. The processor-based system is operable to establish if a current period of inactivity is usual or unusual based on whether the resident is located at the specific location and a comparison of the current period of inactivity with the normal period of inactivity within the structure.

In accordance with another aspect of the present technique, a program is provided. The program comprises programming instructions that enable a processor-based device to develop a model of a person's patterns of activity within a structure based on data received from location and motion sensors. The programming instructions also enable the processor-based device to determine if a current period of inactivity within the structure is a period of normal inactivity or a period of unusual inactivity based on the model of the person's patterns of activity.

### BRIEF DESCRIPTION OF THE DRAWINGS

These and other features, aspects, and advantages of embodiments of the invention will become better understood when the following detailed description is read with reference to the accompanying drawings in which like characters represent like parts throughout the drawings, wherein:

FIG. 1 is a diagrammatic view of a system for detecting when a resident is unusually inactive within a home, illustrating a typical path taken by the resident, in accordance with an exemplary embodiment of the present technique;

FIG. 2 is a diagrammatic view illustrating the transmission of sensor data from the home to a monitoring system operable to identify when a resident is unusually inactive based on the sensor data, in accordance with an exemplary embodiment of the present technique;

FIG. 3 is a flow chart illustrating an exemplary method for developing the adaptive model using the system of FIG. 1, in accordance with an aspect of the present technique;

FIG. 4 is a flow chart illustrating an exemplary method for detecting when a resident is unusually inactive using the system of FIG. 1, in accordance with an exemplary embodiment of the present technique;

FIG. 5 is a diagrammatic view of sensor data representative of a resident incapacitated in bed, in accordance with an exemplary embodiment of the present technique; and

FIG. 6 is a diagrammatic view of sensor data representative of a resident that has fallen down within the home, in accordance with an exemplary embodiment of the present technique.

### DETAILED DESCRIPTION OF EXEMPLARY EMBODIMENTS

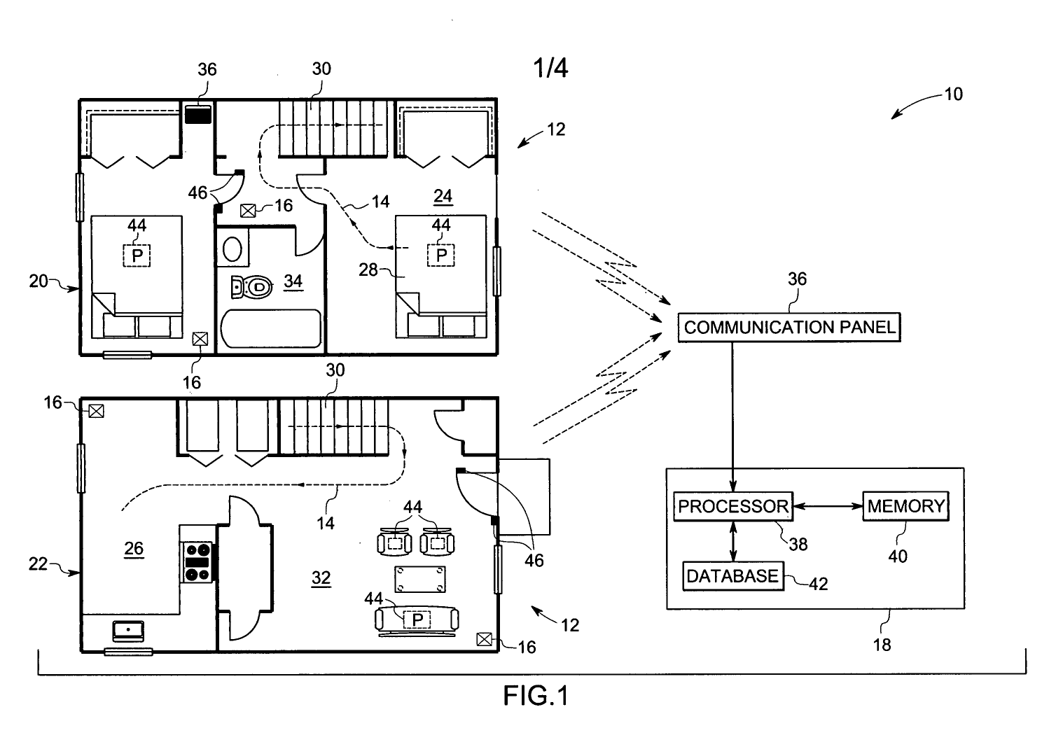

Referring generally to FIG. 1, a home monitoring system 10 operable to detect when a resident of a home 12 is unusually inactive due to a fall or incapacitation is illustrated. The system 10 enables people living independently to receive outside assistance in the event of a fall or other incapacitating event. However, the system 10 is operable in structures other than a home 12. For example, the system 10 may be used in commercial buildings, manufacturing plants, and the like, to monitor the activity of people working alone and to enable assistance to be provided to the person in the event that the person becomes incapacitated.

In the illustrated embodiment, a typical path that may be taken by the resident through the home 12 is represented generally by reference numeral 14. The home monitoring system 10 comprises a plurality of motion sensors 16 that are placed at various locations within the resident's home 12 to identify movement or activity of the resident in various rooms of the home 12, such as when a resident walks along the illustrated path 14. In this embodiment, the motion sensors 16 transmit a signal whenever motion by a person or persons is detected. The motion sensors 16 do not send a signal when the resident is motionless within the home 12. Other sensors may also be utilized to provide data regarding personal activity within the home 12, as will be discussed more fully later in the description. The data collected by the motion sensors 16 is transferred to a monitoring center 18. As will be discussed in greater detail below, the monitoring center 18 is operable to develop a model of the resident's movements and location over a period of time, such that the monitoring center 18 is operable to determine when a period of inactivity within the home 12 is normal or unusual.

In one embodiment, the home 12 has a top floor 20 and a bottom floor 22. However, the home monitoring system 10 is operable for use in single-floor houses, houses with more than two floors, senior apartments, or commercial or residential buildings. Thus, the term structure includes any habitable place that may be used by the resident. The path 14 of the resident illustrated in FIG. 1 is representative of a path that the resident might take in the morning from a master bedroom 24 on the second floor 20 to a kitchen 26 located on the ground floor 22. For example, after getting up from sleeping in a bed 28, the resident would walk down a staircase 30 to the living room 32, and finally to the kitchen 26. However, a resident may take many different paths through the home 12 and the operation of the home monitoring system 10 is not limited to detecting when a person has fallen along the illustrated path 14.

A plurality of motion sensors 16 may be deployed within the resident's home to track the various paths that the resident may take. In this embodiment, the motion sensors 16 that are deployed throughout the resident's home are in wireless communication with a communication panel 36. The communication panel 36 transfers sensor data to the monitoring center 18. The communication panel 36 may be linked to the monitoring center 18 in a number of ways, such as a telephone connection, cable, or an Internet connection.

In the illustrated embodiment, the monitoring center 18 comprises a processor 38 that is in communication with a memory 40. The memory 40 is operable to store programming instructions to enable the system 10 to develop an adaptive model of the resident's behavior and patterns of activity, which is then used to control the operation of the processor 38. The processor 38 is also in communication with a database 42 that stores the various types of sensor data. The data generated by the adaptive model may also be stored in the database 42.

There are several different types of sensors that may be used to provide data to the monitoring center 18. The motion sensors 16 that are deployed throughout the resident's home may be any of a variety of different types of motion sensors, such as a passive infrared sensor, an ultrasound sensor, a microwave sensor, a radar sensor, an infrared sensor, etc. In addition, location sensors 44 and door switches 46 may be deployed to provide data regarding the specific location and/or specific activities of the resident within the home 12. The location sensors 44 may comprise pressure pad sensors, infrared sensors, and other sensors that can detect when the resident is located at specific locations within the home 12, such as when the resident is in bed, sitting on a couch or a chair, or when located at some other specific location. Similarly, the door switches 46 provide information to the monitoring center 18 about the resident entering or leaving the building, traveling from one room to another, or performing specific activities, such as opening drawers, accessing a cabinet, refrigerator, etc. The door switches 46 may be magnetic switches, laser sensors, infrared sensors, or some other type of device operable to provide an indication when a door is either shut or closed.

In the illustrated embodiment, the location sensors 44 are disposed at resting places where the resident would be expected to be stationary for extended periods of time. Therefore, a person located at one of these resting places would not be expected to trigger the motion sensors 16 as long as they are located at these resting places. For example, location sensors 44 may be disposed in a bed, a chair, a couch, etc. The location sensors 44 transmit a signal to the communication panel 36 when the resident is located in the bed or sitting in the chairs or on the couch. Similarly, once the resident gets out of the bed, chair, or couch, the location sensor 44 ceases to transmit the signal to the monitoring center 18, thereby indicating that the resident is no longer at that location. However, other methods of operation of the location sensor 44 and monitoring center 18 may be used. In addition, other locations where the resident may be expected to sit or stand for extended periods may be provided with a location sensor 44. The door switches 46 transmit signals when the doors are opened or closed to inform the monitoring center 18 when the resident is entering and leaving the house 12 or the various rooms. In addition, door switches 46 may be installed on cabinet doors, drawers, etc., to provide resident activity information to the monitoring center 18.

The location sensors 44 enable the system to more quickly recognize when the resident has fallen down. When a resident is located at one of the locations where location sensors 44 are located, such as in bed, sitting in a chair, or sitting on a couch, the resident presumably has not fallen. Therefore, a long period of motionless activity is not indicative that the resident has fallen when the resident is located at one of the specific locations. Conversely, there is a greater likelihood that the resident has fallen when the resident is not at one of the locations having a location sensor 44 and there is a period of inactivity. Therefore, the location sensors 44 enable the system to disregard the long periods of inactivity that occur when the resident is sitting or sleeping when establishing a period of time of motionless activity as being indicative that the resident has fallen. Thus, the period of inactivity needed for the monitoring center 18 to be able to establish that the resident has fallen can be reduced significantly. As a result, this enables the monitoring center 18 to direct a caregiver to the home 12 much more quickly when the person has fallen down.

The illustrated monitoring center 18 is able to learn the resident's normal patterns of activity and to use the resident's normal patterns of behavior to establish the period of time of motionless activity used to trigger the monitoring center 18 to recognize that the resident may have fallen. For example, a resident's normal pattern of behavior may be to sleep in bed at night. The resident's normal pattern of behavior may include periodically getting out of bed for a certain period of time in order to use the bathroom. The monitoring center 18 is operable to recognize that the person gets out of bed periodically and to establish the period of inactivity indicative that the resident has fallen based on the period of time that the resident is usually out of bed at night. Therefore, if the person does get out of bed and falls down, the monitoring center 18 will quickly establish that the resident has fallen down. Similarly, a person may spend an extended period of time sitting in a chair watching TV. The location sensors 44 enable the system to identify these periods of inactivity from a fall or other type of incapacitation. This also enables the duration of inactivity that is needed for the system to identify the person as having fallen to be shortened. For example, the system would not expect the person to be up and active at night. Therefore, if the person falls at night, the system may not recognize the person as having fallen until the morning, or later. However, by having the location sensor 44 on the bed, the system knows if the person gets out of bed at night. Therefore, if a period of inactivity follows, the system can identify the person as having fallen before the person would be expected to be active in the morning.

The motion sensors 16, the location sensors 44, and the door switches 46 illustrated in FIG. I enable the system 10 to monitor the resident's activity and/or movements in the various rooms within the home 12, so that the system may identify when the resident is exhibiting unusual inactivity, such as having fallen and not being able to get up, not getting out of bed in the morning at a usual time, remaining out of bed for an unusual period of time at night, remaining in a bathroom for an unusual period of time, or simply being in a room with a motion sensor and no motion being detected for an extended period of time.

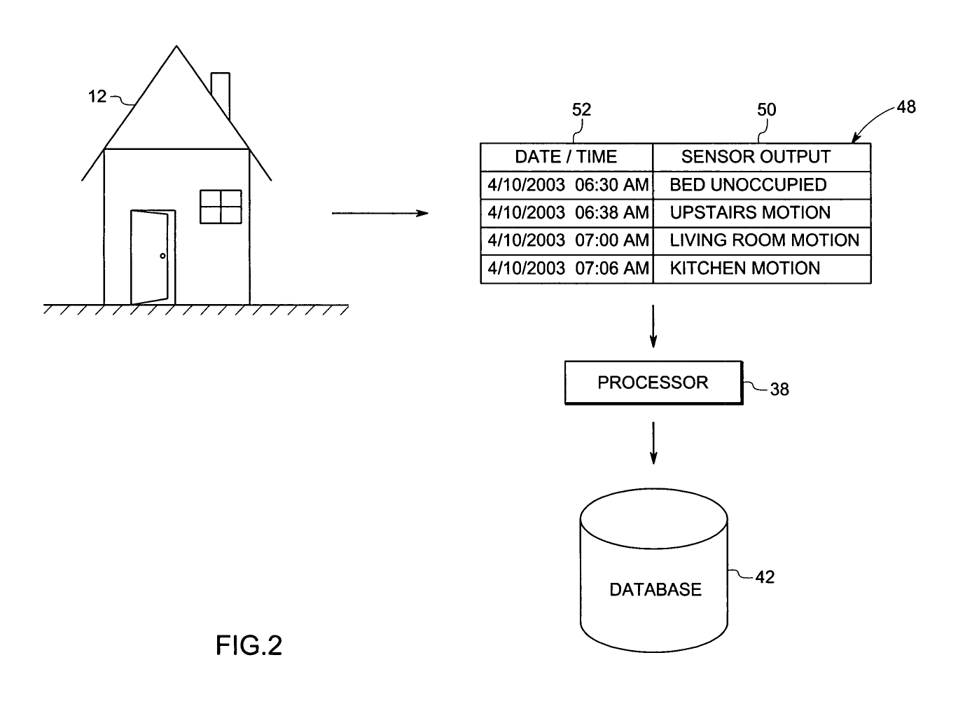

Referring generally to FIG. 2, an example of sensor data 48 that may be used by the monitoring center 18 is illustrated. As described above, the data 48 collected via the sensors 16, 44, and 46, is transmitted to the monitoring center 18 for processing and storage. In this embodiment, the sensor data 48 comprises sensor information 50, such as the specific sensor providing the data and the activity detected. In addition, the sensor data 48 also comprises temporal information 52, such as the date and the time that the specific sensor provided the sensor information 50. This information may be provided by the monitoring center 18. For example, as illustrated, at 6:30 a.m. on Apr. 10, 2003, the monitoring center 18 concludes that the resident got out of the bed when a location sensor 44 on the bed 28 in the master bedroom 24 ceases to transmit the signal indicative of the occupation of the bed 28. The sensor data 48 also indicates that the motion of the resident was detected upstairs by a motion sensor 16 at 6:38 a.m. The sensor data 48 further indicates that motion was detected by a motion sensor 16 located in the living room 32 at around 7:00 a.m. Furthermore, the data 48 also indicates that a motion sensor installed in the kitchen 26 detected motion at 7:06 a.m.

From the sensor data 48 provided above, the monitoring center 18 can conclude that the resident is active and that there is no unusual inactivity. The data 48 indicates that the resident got out of bed 28 in the master bedroom 24 at around 6:30 a.m., and after stopping for a while in the master bedroom 24, proceeded to the staircase 30. The resident walked down the staircase 30 to the living room 32 at 7:00 a.m., which may indicate that the resident took a slow climb down the staircase 30 to the living room 32, and then walked from the living room 32 to the kitchen 26 at 7:06 a.m. The resident may have spent some time in the living room before finally walking to the kitchen. The time between indications of motion of the resident in the home 12 is utilized to establish if the resident is experiencing a period of unusual inactivity, such as falling down and being unable to get up or being sick in bed. In other words, the resident's last detected motion/location is registered and is used to estimate the period of inactivity therefrom. The time between indications of a resident's activity is determined by the processor 38 and may be stored in the database 42.

The monitoring center 18 develops an adaptive model that is stored in memory 40 and is operable to identify patterns in a resident's behavior so that a determination can be made as to whether a resident's period of inactivity is usual or unusual. For example, if the resident typically gets out of bed at 6:30 a.m. every morning, the adaptive model might identify this as a trend and use this as a standard for comparison. If on a given day the resident is in bed at some time after 6:30 a.m., the system may identify this as evidence of an unusual inactivity based on the adaptive model. It may be noted that the adaptive model is developed over a period of time based on parameters such as last detected motion, location, time of the day, etc. Thus, the adaptive model will learn the resident's behavior, habits, and patterns of activity over a period of time.

In one example of the operation of the system, the location sensors 44 provide no signal indicating that the resident is occupying any of the chairs, couches or the beds having a location sensor 44. However, at least one motion sensor 16 transmits a signal indicating that the resident is moving about the home 12. Therefore, the system concludes that the person is active and has not fallen down or is incapacitated.

Alternatively, if the monitoring center 18 receives no indication of any motion of the person within the home 12 and the location sensors 44 indicate that the person is not occupying any of the seating locations such as beds, chairs, couches, etc. due to the lack of a signal from the various location sensors 44, the system issues an alert to the caregiver. As noted above, one advantage of the present system is that the monitoring center 18 is able to identify that the resident has fallen in a shorter period of time than a system that relies solely on motion sensors 16 and/or door switches 46. Thus, the system can issue an alert to the caregiver without waiting for a long period of time to ascertain whether the person is watching television, sleeping, or reading or performing some other normal activity that would not trigger the motion sensors 16 or door switches 46. Since the resolution of the activity/inactivity data provided by the sensors is high in such a case, the sensitivity of the system to detect falling, or incapacitation of the person is also high.

In another example of the operation of the system, if the location sensors 44 indicate that the resident is occupying any one of the seating locations or the bed, the monitoring center 18 recognizes that the person is at a known location and therefore disregards or subjugates any indications of inactivity provided by the motion sensors 16. Thus, inadvertent alarms are minimized.

However, the monitoring center 18 may be programmed to alert a caregiver when a person occupies one of the locations having a location sensor 44 for an excessive period of time, such as if the person became incapacitated. This period of time may be based on the resident's normal patterns of behavior. As had been explained before, the system is capable of developing an adaptive model based on the person's habits, behavior, and patterns of movement over a period of time. Any deviations from the usual behavior of the person while occupying the various seating locations and/or beds may be utilized by the system to trigger an alert. For example, it may be usual for the person to occupy the bed for a specific number of hours each day. If however, the system indicates that the person is occupying the bed for a duration that the adaptive model establishes as unusual, then the system is capable of recognizing that such a condition is representative of the resident possibly being incapacitated. It may be noted that the system achieves a high level of sensitivity over a period of time in judging a period of inactivity as unusual, based on the type of activity, duration of inactivity, time of the day, etc. Furthermore, the various location sensors 44 installed on various seating locations and beds may be configured to respond to similar conditions of incapacity of the person, such that the system may conclude that the person is incapacitated after different durations of inactivity at different locations. For example, the duration of inactivity before the system concludes that the person is incapacitated when the person is lying on a bed may be different from the duration of inactivity corresponding to another location, such as a chair or a couch.

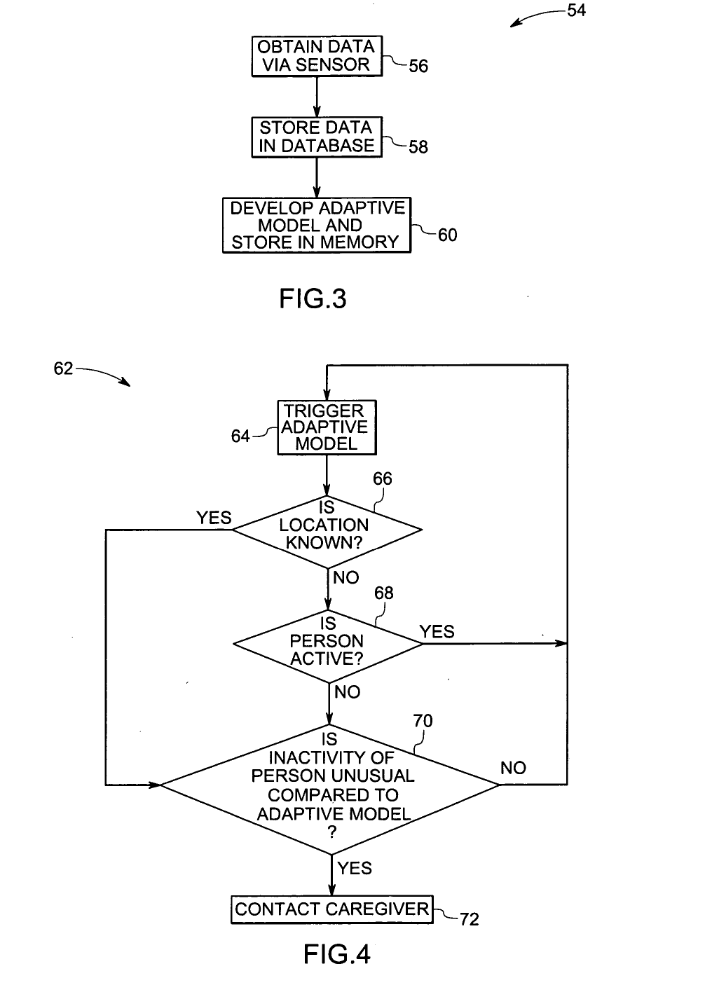

Referring generally to FIG. 3, a flow chart illustrating an exemplary method for developing the adaptive model using the system of FIG. 1, is illustrated generally by reference numeral 54. In the illustrated process, sensor data 48 is obtained from the sensors, as represented generally by block 56. The sensor data is stored in the database 42 for future use, as represented by block 58. The monitoring center 18 receives the sensor data 48 and determines whether the sensor data 48 indicates that the resident is moving or not, therefore active or inactive. When the sensor data 48 indicates that the resident is moving, the processor 38 updates the adaptive model stored in memory 40, as represented by block 60. Similarly, if the resident is not moving and the sensor data 48 indicates that the resident is located at one of the various seating locations or a bed, this data will also be updated into the database. Any data that may be generated by the adaptive model may also be stored in the database 42.

The sensor data 48 and any data generated by the adaptive model may be used at a later time for detection of unusual inactivity by the system 10. FIG. 4 illustrates a flow chart showing an exemplary process for detecting when a resident is unusually inactive using the system 10 of FIG. 1. The illustrated process, generally represented by reference numeral 62, begins with the triggering of the adaptive model stored in the memory 40, as represented by block 64. Triggering of the adaptive model may be configured to occur periodically, whenever sensor data 48 is received, or if the status of the home changes in some way.

The monitoring center 18 checks the location of the person within the home, as represented by block 66. If the location of the person is not known, then evidence of the resident's activity or movement is checked, as represented by block 68. If the person is found to be active within the home, then the system concludes that the person is active and everything is normal. The adaptive model may then be triggered again at a later time, or when sensor data 48 is received by the system, or when the status of the home changes in some way, as described above.

If the location is known, the duration of occupancy of the seating location or bed by the resident is compared against the current time of day for the current location using the adaptive model, as represented by block 70. However, if the location is not known, and the person is also not showing any movement within the home, then the current period of inactivity is compared to the adaptive model, as represented by block 70. If the adaptive model indicates that it is not uncommon for the resident to be inactive at this time of day in this location for this long, the system concludes that the person may be inactive, but such inactivity is normal at this point in time. For example, a resident may prepare food in the kitchen 26. While in the kitchen 26, the resident may move around. The motion sensor 16 will detect this movement. If the resident typically sits relatively motionless at a table (or simply stands near a table) in the kitchen 26 every morning for a certain period of time, the motion sensor would indicate that there is no motion in the kitchen 26. Because this is part of the normal pattern of behavior of the resident, the adaptive model would recognize that the person being motionless for that period of time is normal. The time of the day may facilitate identification of a usual pattern or tendency of the resident. In such a case, the adaptive model may once again be triggered at a later time, or when sensor data 48 is received by the system, or when the status of the house changes in some other way.

If the current period of inactivity is more than a predefined period of time for that location, for that time of the day, the monitoring center 18 may consider this period of inactivity as unusual. It may be noted that the adaptive model establishes the predefined period of time for a location that may be considered as unusual or usual, and will continue to update the same over a period of time. Consequently, the monitoring center 18 may contact a caregiver, as represented by block 72. It may be noted that various types of alarms or alerts for the caregiver may be actuated if needed, which may include an electronic mail, a tele-text (such as a paged message, or a short message on a cell phone), a visual signal, an audible signal, a textual signal, or any combinations of the aforementioned alerts. The caregiver may also call the person to inquire about the person's well being in this scenario. In one embodiment, the system automatically attempts to call the resident when the monitoring system establishes that the resident is experiencing an unusual period of inactivity. However, when the resident does not respond to the call, the system automatically contacts the caregiver in the aforementioned manner. It will be also appreciated by one skilled in the art that in alternative implementations, the functions noted in the blocks may occur in an order different from that noted in FIG. 4, so that the monitoring center 18 checks the movement of the person within the home before checking the location of the person within the home.

As noted above, the adaptive model is configured to learn or adapt to the resident's activity habits over time. Such a scheme enables unusual periods of inactivity to be identified quickly without simply using a set time period of inactivity as the determining factor. The adaptive model leverages information such as the time of day, duration of inactivity, and last location of the resident to assess whether the current combination of factors is unusually abnormal. Furthermore, the adaptive model is constructed with information from a number of previous days, weeks, or months to identify the variation of the resident's patterns. In addition, the adaptive model may rely on events leading to the current time, such as a series of locations or duration of prior activity to further assess whether inactivity is unusual. For example, it may be most likely that around the evenings, the resident spends some time in a balcony. Such a period of inactivity, which may last for a longer period than usual periods of inactivity, may be established by the adaptive model as normal, over a period of time. The adaptive model also minimizes erroneous alarms or alerts that may be generated by the system when the resident is inactive for prolonged periods of time, but which are not unusual for that resident. Furthermore, the system 10 is also able to identify if the resident falls at night, a period when it would be expected that the resident is not active. For example, if the resident gets out of bed at night to use the bathroom, the location sensor 44 will cease sending a signal to the monitoring center 18, indicating that the resident is out of bed. Thus, the monitoring center 18 would begin establishing a period of inactivity for the resident until either the person got back into bed or caused at least one upstairs motion sensor to indicate motion. However, if the resident fell in this scenario, the length of time that the resident was on the floor before the system 10 would recognize that the resident had fallen would be relatively short because the adaptive model would expect the resident to either trigger an upstairs motion sensor or get back into bed in a relatively short period of time.

Similarly, if motion is detected in the living room 32 and the door to the outside is opened, the door switch 46 would send a signal to the monitoring center 18. In such a case, the adaptive model would recognize that the resident had walked out of the home 12. The adaptive model would not consider any subsequent period of inactivity as unusual until the resident returned, thus preventing erroneous alarms or alerts. When the resident again enters the home, the door switches may detect the opening and closing of the door. However, before the adaptive model concludes that the resident has actually entered the home, the adaptive model may confirm that the resident has entered the home by checking for an indication of movement from the motion sensors 16 installed near the door. Thus, supplementing the data provided by the door switches, with data provided by motion sensors, is useful when resident may just open the door and then closes it without entering the home. In such a case, the adaptive model may not search for patterns within the home, thus preventing erroneous alarms. The adaptive model may consider such quite times outliers that are not to be considered in developing the adaptive model. This scheme retains the high level of sensitivity of the system.

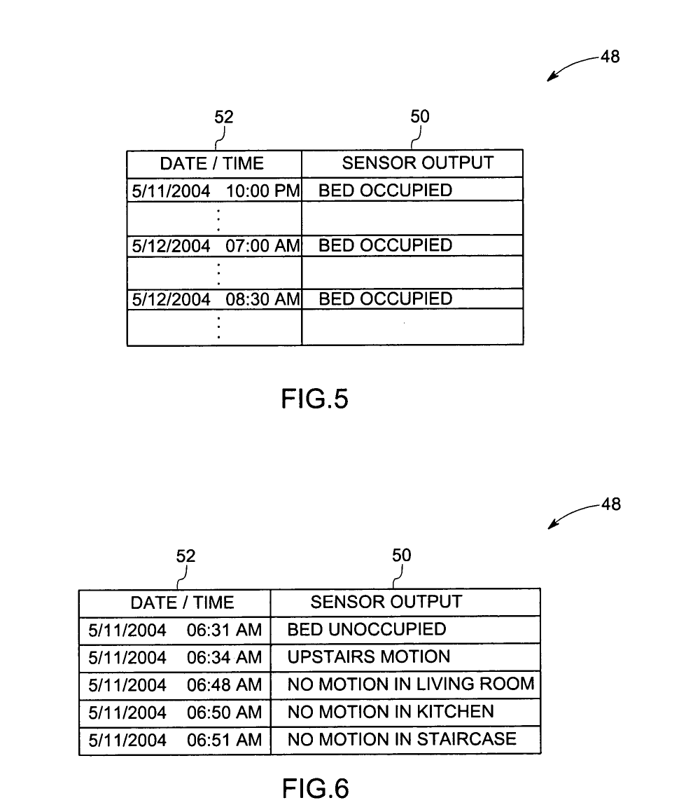

The type of data 48 generated by the sensor during different conditions and instances will become better understood with respect to FIG. 5, which is a tabulation illustrating the sensor data 48 that may be generated when the resident may be incapacitated or too sick to get out of bed. In the exemplary illustration of FIG. 5, the sensor information 50 and temporal information 52 are illustrated. In this example, the resident may be indicated as having occupied the bed at around 10:00 pm on May 11, 2004. The location sensor 44 on the mattress of the bed may indicate the presence of the resident throughout the night, continuing the next day past 8:30 a.m. This may be usual for this resident. However, in cases when the resident typically gets out of the bed at, for example, around 6:00 a.m., this likely would be considered a period of unusual inactivity. The period of inactivity may be attributed to the resident being incapacitated or too sick to get out of the bed. In such a case, as previously described, an alarm or an alert may be generated by the system, so that the caregiver may be notified to provide assistance to the resident. FIG. 5 is, however, indicative of only one type of data that may be generated in such cases. Various other types of sensor data may be generated as will be appreciated by one skilled in the art.

Similarly, FIG. 6 shows tabulation of another type of sensor data generated when the resident may have fainted or fallen down within the home, in accordance with one aspect of the present technique. The sensor data 50 may indicate a motion in the staircase, at around 6:34 a.m., after the resident left the bed at around 6:31 a.m. on May 11, 2004. Later, the sensor data 48 may indicate inactivity or having registered no motion in the various locations of the home like the living room, kitchen, or staircase. Since the last detected motion was around the staircase, such a case may indicate that the resident might have stumbled over from the staircase or may indicate that the resident might have fainted or fallen down upstairs.

One skilled in the art will appreciate that the system also may be utilized to determine and report unusual activity of a resident. For example, the system may be configured to detect a case when the resident exhibits activity when the resident would not normally be expected to be active, such as activity at night when the resident would be expected to be sleeping. Furthermore, the system may be configured to detect cases when the resident is exhibiting activity at a location where it is not normal for the resident to exhibit activity. Similarly, the system may be configured to detect sleepwalking.

It will be appreciated by those skilled in the art that the methods and algorithms described hereinabove may be embedded in a dedicated processor such as an ASIC (application specific integrated circuit) or, a digital signal processor configured for processing the signals. Alternatively, computer readable instructions may be embedded in the processor of the monitoring center 18 to process the above mentioned sensor data.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A system for detecting when a person occupying a structure is exhibiting a period of unusual inactivity, comprising:
at least one location sensor operable to detect when the person is located at a specific location within the structure and to provide a signal when the person is located at the specific location;
at least one motion sensor operable to detect activity within the structure and to provide a signal when the at least one motion sensor detects activity within the structure; and
a processor-based system programmed to establish a normal period of inactivity within the structure based on signals received from the at least one location sensor and the at least one motion sensor, and wherein the processor-based system is operable to establish if a current period of inactivity is unusual based on whether the resident is located at the specific location and a comparison of the current period of inactivity with the normal period of inactivity within the structure.

2. The system as recited in claim 1, wherein the processor-based system establishes a first period of time as being a normal period of inactivity based on the person not being located at the specific location.

3. The system as recited in claim 2, wherein the processor-based system establishes a second period of time as being a normal period of inactivity based on the person being located at the specific location.

4. The system as recited in claim 3, wherein the first period of time is shorter than the second period of time.

5. The system as recited in claim 1, wherein the at least one location sensor comprises a pressure pad sensor operable to provide a signal when the person is sitting on the pressure pad sensor.

6. The system as recited in claim 1, wherein the at least one motion sensor comprises a switch configured to provide a signal when a door is one of opened or closed.

7. The system as recited in claim 1, wherein the processor-based system provides a signal to alert a caregiver when an unusual period of inactivity is identified.

8. The system as recited in claim 1, wherein the processor-based system is disposed at a remote location.

9. A system for detecting a period of unusual inactivity of a person, comprising:
a monitoring system in communication with at least one location sensor operable to detect when the person is located at a specific location within a residence and at least one motion sensor operable to detect movement within the residence, wherein the monitoring system comprises a processor-based device programmed to develop a model of the person's patterns of activity within the residence based on data received from the at least one location sensor and the at least one motion sensor, and wherein the processor-based device is programmed to determine if a current period of inactivity within the residence is a period of normal inactivity or a period of unusual inactivity based on the model of the person's patterns of activity within the residence.

10. The system as recited in claim 9, wherein the at least one location sensor comprises a plurality of location sensors, each of the plurality of location sensors being disposed at a resting place within the residence.

11. The system as recited in claim 9, wherein the at least one motion sensor comprises a plurality of motion sensors dispersed about the residence.

12. The system as recited in claim 9, wherein the model of the person's patterns of activity comprises temporal data for each movement within the residence detected by the at least one motion sensor.

13. The system as recited in claim 9, wherein the processor-based device is programmed to determine that the current period of inactivity is a period of normal inactivity when the person is located at the specific location.

14. The system as recited in claim 13, wherein the processor-based device is programmed to determine that the current period of inactivity is a period of unusual inactivity when the person is inactive for a defined period of time established by the model of the person's patterns of activity within the residence as being representative of a period of unusual inactivity of the person within the residence.

15. The system as recited in claim 9, wherein the monitoring system is operable to alert a caregiver that the person is experiencing the period of unusual inactivity.

16. A computer program, comprising:
programming instructions stored in a tangible medium, wherein the programming instructions enable a processor-based device to develop a model of a person's patterns of activity within a residence based on data received from at least one location sensor and at least one motion sensor, and wherein the programming instructions enable the processor-based device to determine if a current period of inactivity within the residence is a period of normal inactivity or a period of unusual inactivity based on the model of the person's patterns of activity.

17. The program as recited in claim 16, comprising programming instructions operable to enable the processor-based device establish a normal period of inactivity within the residence.

18. The program as recited in claim 17, comprising programming instructions operable to enable the processor-based device to produce a signal when the current period of inactivity exceeds the normal period of inactivity.

19. The program as recited in claim 16, comprising programming instructions operable to enable the processor-based device establish a normal time of day that there is activity within the residence.

20. A method for detecting when a resident has fallen down within a structure, comprising:
detecting when the resident is not located at a defined location within the structure;
detecting when the resident is inactive;
establishing a period of inactivity of the resident when the resident is not located at the defined location within the structure and the resident is inactive; and
comparing the period of inactivity of the resident when the resident is not located at the defined location within the structure and the resident is inactive with an adaptive model of the resident's normal patterns of activity to determine if the period of inactivity of the resident when the resident is not located at the defined location within the structure is unusual.

21. The method as recited in claim 20, comprising:
establishing a period of the resident being located at the defined location within the structure; and
comparing the period of the resident being located at the defined location within the structure with the adaptive model of the resident's normal patterns of activity to determine if the period of the resident being located at the defined location within the structure is unusual.

22. The method as recited in claim 20, comprising developing the adaptive model of the resident's normal patterns of activity based on tracking when the resident is located at the defined location within the structure and when the resident is not located at the defined location within the structure.

23. The method as recited in claim 22, wherein developing the adaptive model of the resident's normal patterns of activity is based on tracking when the resident is active and when the resident is inactive.

24. The method as recited in claim 23, wherein developing the adaptive model of the resident's normal patterns of activity is based on tracking where in the structure the resident is active and where in the structure the resident is inactive.

25. The method as recited in claim 20, comprising:
automatically attempting to contact the resident when the system establishes that the period of inactivity of the resident is unusual; and
attempting to contact a caregiver if the resident does not respond to an attempt to contact the resident.

26. The method as recited in claim 20, comprising automatically attempting to contact a caregiver when the system establishes that the resident is experiencing a period of unusual inactivity.

27. A method of providing assistance to a person in an event of the person becoming incapacitated, comprising:
operating a monitoring system to develop a model of the person's patterns of activity and inactivity within a structure using at least one motion sensor operable to detect motion of the person and at least one location sensor operable to detect when the person is located at a specific location within the structure;
operating the monitoring system to monitor the person's activity within the structure to identify a period of inactivity within the structure when the person is not located at the specific location as being unusual based on the model of the person's patterns of activity and inactivity within a structure; and
at least one of contacting the person and a caregiver when the monitoring system identifies the person as being in a period of unusual inactivity.

28. The method as recited in claim 27, wherein the model of the person's patterns of activity and inactivity within the structure is based on data received from the at least one motion sensor and the at least one location sensor.

29. The method as recited in claim 28, wherein the monitoring system is operable to establish a duration of inactivity between each indication of movement detected by the at least one motion sensor and to store each duration of inactivity data in a memory, and wherein the model of the person's patterns of activity and inactivity within a structure is based on the duration of inactivity data stored in memory over a period of time.

30. A system for identifying when a person has become unusually inactive, comprising:
at least one location sensor operable to provide a signal representative of the person's occupancy of a specific location;
at least one movement sensor operable to provide a signal representative of movement by the person; and
a processor-based device in communication with the at least one location sensor and the at least one movement sensor, wherein the processor-based device is operable to determine if a current period of inactivity is unusual based on the signal representative of the person's occupancy of a specific location and the signal representative of movement by the person.

31. The system as recited in claim 30, wherein the processor-based device is programmed to identify the person as having fallen when the at least one location sensor indicates that the person is not occupying the specific location and the current period of inactivity exceeds a first defined period of inactivity.

32. The system as recited in claim 30, wherein the processor-based device recognizes a period of inactivity as being a period of normal inactivity if the person is occupying the specific location for a second defined period of inactivity.

33. The system as recited in claim 32, wherein the processor-based device is programmed to identify the person as having been incapacitated when the at least one location sensor indicates that the person is occupying the specific location and the current period of inactivity exceeds the second defined period of inactivity.

34. The system as recited in claim 30, wherein the at least one location sensor comprises a pressure pad operable to provide a signal when a person is disposed on the pressure pad.

35. A system for detecting when a person is experiencing a period of unusual activity, comprising:
at least one location sensor operable to detect when the person is located at a specific location within a structure and to provide a signal when the person is located at the specific location;
at least one motion sensor operable to detect activity within the structure and to provide a signal when the at least one motion sensor detects activity within the structure; and
a processor-based system programmed to establish a normal period of activity within the structure based on signals received from the at least one location sensor and the at least one motion sensor, and wherein the processor-based system is operable to establish if a current period of activity is unusual based on whether the resident is located at the specific location and a comparison of the current period of activity with the normal period of activity within the structure.

36. The system as recited in claim 35, wherein the system establishes the normal period of activity based on the time of day.

37. The system as recited in claim 36, wherein the system comprises a plurality of motion sensors disposed in different rooms of the structure, and the system establishes the normal period of activity based on activity detected in each of the different rooms of the structure.

38. The system as recited in claim 35, wherein the at least one location sensor comprises a pressure pad sensor operable to provide a signal when the person is sitting on the pressure pad sensor.

39. The system as recited in claim 35, wherein the processor-based system provides a signal to alert a caregiver when an unusual period of activity is identified.

40. The system as recited in claim 35, wherein the processor-based system is disposed at a remote location.
